(19) United States
(12) Patent Application Publication
(10) Pub. No.: US 2018/0361743 A1
(43) Pub. Date: Dec. 20, 2018

(54) LIQUID EJECTION DEVICE

(71) Applicant: BROTHER KOGYO KABUSHIKI KAISHA, Nagoya-shi (JP)

(72) Inventors: Taisuke MIZUNO, Nagoya-shi (JP); Yasuo KATO, Chita-gun (JP); Takashi AIBA, Nagoya-shi (JP); Keita SUGIURA, Toyoake-shi (JP)

(21) Appl. No.: 16/113,526

(22) Filed: Aug. 27, 2018

Related U.S. Application Data
(62) Division of application No. 15/259,506, filed on Sep. 8, 2016, now Pat. No. 10,071,553.

(30) Foreign Application Priority Data
Sep. 8, 2015 (JP) 2015-176295

(51) Int. Cl. B41J 2/14; B41J 2/175; B41J 2/055

(52) U.S. Cl. CPC B41J 2/14233; B41J 2/175; B41J 2/17556; B41J 2002/14419; B41J 2002/14491; B41J 2/055

(57) ABSTRACT

A liquid ejection device is disclosed. One device includes a liquid supply member defining a liquid supply channel that is in communication with a common liquid chamber via an outlet of the liquid supply channel. The outlet and the common liquid chamber extend along a longitudinal direction respectively. The liquid supply member includes a plurality of ribs located within the liquid supply channel, the plurality of ribs are disposed side by side in the longitudinal direction. The plurality of ribs includes a first rib, a second rib and a third rib. A distance from the first rib to the third rib in the longitudinal direction is smaller than a distance from the first rib to the second rib in the longitudinal direction.

### CROSS-REFERENCE TO RELATED APPLICATION

This application is a divisional application of U.S. Ser. No. 15/259,506 filed on Sep. 8, 2016 and claims priority from Japanese Patent Application No. 2015-176295, filed on Sep. 8, 2015, which is incorporated herein by reference in its entirety.

### TECHNICAL FIELD

The disclosure relates to a liquid ejection device for ejecting liquid from nozzles.

### BACKGROUND

A known liquid ejection device includes a channel-defining substrate and a case member. The channel-defining substrate has a plurality of pressure chambers arranged along a nozzle-row extending direction. The case member has a manifold extending along the nozzle-row extending direction.

### SUMMARY

In the manifold of the known liquid ejection device, while an ink flow speed increases at a central portion of the manifold in the lengthwise direction, the ink flow speed may decrease at end portions of the manifold in the lengthwise direction. Therefore, an ink supply amount may vary among nozzles, and thus refill performance may vary among the nozzles.

Accordingly, some embodiments of the disclosure provide for a liquid ejection device in which liquid supply variation among nozzles may be surely reduced.

According to one aspect of the disclosure, a liquid ejection device includes a liquid supply member defining a liquid supply channel that is in communication with a common liquid chamber via an outlet of the liquid supply channel. The outlet and the common liquid chamber extend along a longitudinal direction respectively. The liquid supply member includes a plurality of ribs located within the liquid supply channel. The plurality of ribs are disposed side by side in the longitudinal direction. The plurality of ribs includes a first rib, a second rib and a third rib. The second rib is disposed in a first direction of the first rib. The first direction is in the longitudinal direction. The second rib is adjacent to the first rib. The third rib and an inlet of the liquid supply channel are disposed in a second direction of the first rib. The second direction is in the longitudinal direction and opposite to first direction. The third rib is adjacent to the first rib. A distance from the first rib to the third rib in the longitudinal direction is smaller than a distance from the first rib to the second rib in the longitudinal direction.

According to one aspect of the disclosure, liquid supply variation in the common liquid chamber with respect to the first direction may be reduced. Further, pressure fluctuation in the common liquid chamber that may be caused by excessive increase of a liquid flow speed at the central portion (e.g., a portion close to a supply channel) of the common liquid chamber may be reduced.

According to further aspect of the disclosure, a liquid ejection device is disclosed. The liquid ejection device includes a liquid supply member defining a liquid supply channel that is in communication with a common liquid chamber via an outlet of the liquid supply channel. The outlet and the common liquid chamber extends along a longitudinal direction respectively. The outlet is divided into a plurality of sub-outlets in the longitudinal direction. The plurality of sub-outlets includes a first sub-outlet and a second sub-outlet. The first sub-outlet is adjacent to the second sub-outlet. A distance from an inlet of the liquid supply channel to the first sub-outlet in the longitudinal direction is smaller than a distance from the inlet to the second sub-outlet in the longitudinal direction. A length of the first sub-outlet in the longitudinal direction is smaller than a length of the second sub-outlet in the longitudinal direction.

### BRIEF DESCRIPTION OF THE DRAWINGS

Aspects of the disclosure are illustrated by way of example and not by limitation in the accompanying figures in which like reference characters indicate similar elements.

FIG. 1 is a schematic diagram depicting a printer in an illustrative embodiment according to one or more aspects of the disclosure.

FIG. 2 is a plan view depicting an inkjet head in the illustrative embodiment according to one or more aspects of the disclosure.

FIG. 3 is a sectional view taken along line III-III in FIG. 2 in the illustrative embodiment according to one or more aspects of the disclosure.

FIG. 4 is a plan view depicting an inkjet head in a first variation of the illustrative embodiment according to one or more aspects of the disclosure.

FIG. 5 is a sectional view taken along line IV-IV in FIG. 4 in the first variation of the illustrative embodiment according to one or more aspects of the disclosure.

FIG. 6 is a plan view depicting an inkjet head in a second variation of the illustrative embodiment according to one or more aspects of the disclosure.

FIG. 7 is a plan view depicting an inkjet head in a third variation of the illustrative embodiment according to one or more aspects of the disclosure.

### DETAILED DESCRIPTION

Hereinafter, an illustrative embodiment will be described in detail with reference to the accompanying drawing, like reference numerals being used for like corresponding parts in the various drawings. Common elements will be indicated by common numbers or letters without distinguishing letters or numbers when not distinguishing therebetween.

(Overall Configuration of Printer)

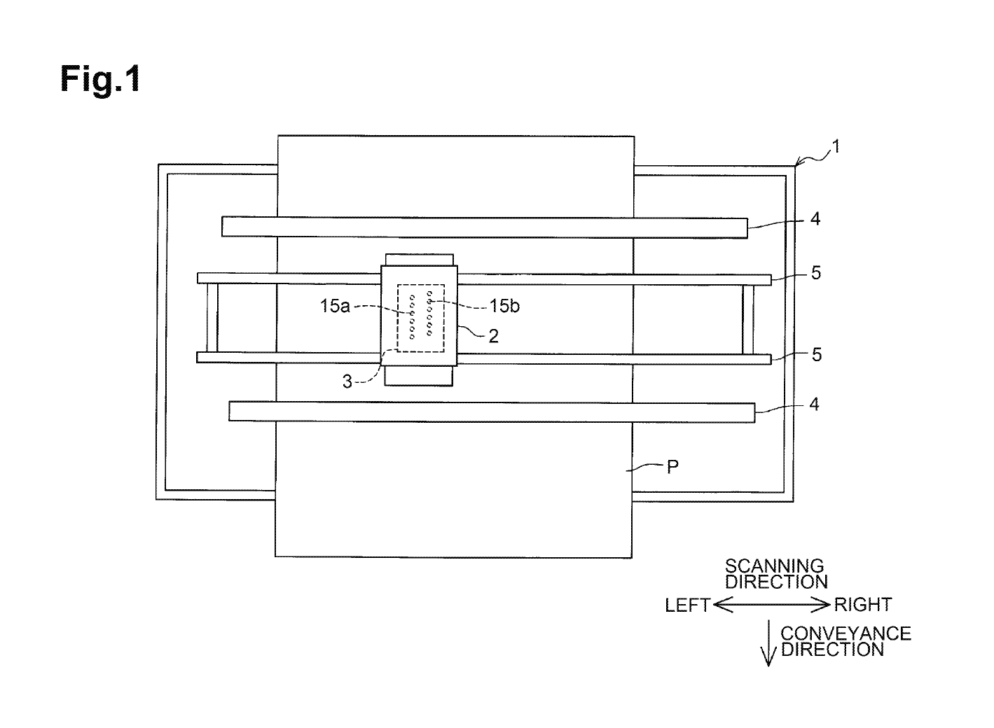

As depicted in FIG. 1, a printer 1 according to the illustrative embodiment includes a carriage 2, an inkjet head 3, and sheet conveyor rollers 4. The carriage 2 is supported by a plurality of, for example, two, guide rails 5 and reciprocates in a scanning direction (as an example of a third direction) along the guide rails 5. The inkjet head 3 is mounted on the carriage 2, and has a plurality of nozzles 15a and 15b in a lower surface thereof. The sheet conveyor rollers 4 are disposed on opposite sides of the carriage 2 with respect to a conveyance direction. The sheet conveyor rollers 4 convey a recording sheet P along the conveyance direction (as an example of a first direction). The conveyance direction may be a direction orthogonal to the scanning direction. As depicted in FIG. 1, the scanning direction may be bidirectional and one of the scanning direction may be defined as right and the other of the scanning direction maybe defined as left.

Upon receipt of a print instruction, the printer 1 starts conveying a recording sheet P and reciprocating the carriage 2 in synchronization with the sheet conveyance. In accordance with this, the printer 1 drives the inkjet head 3 to eject ink from the nozzles 15a and 15b, thereby forming an image based on image data on the recording sheet P.

(Inkjet Head)

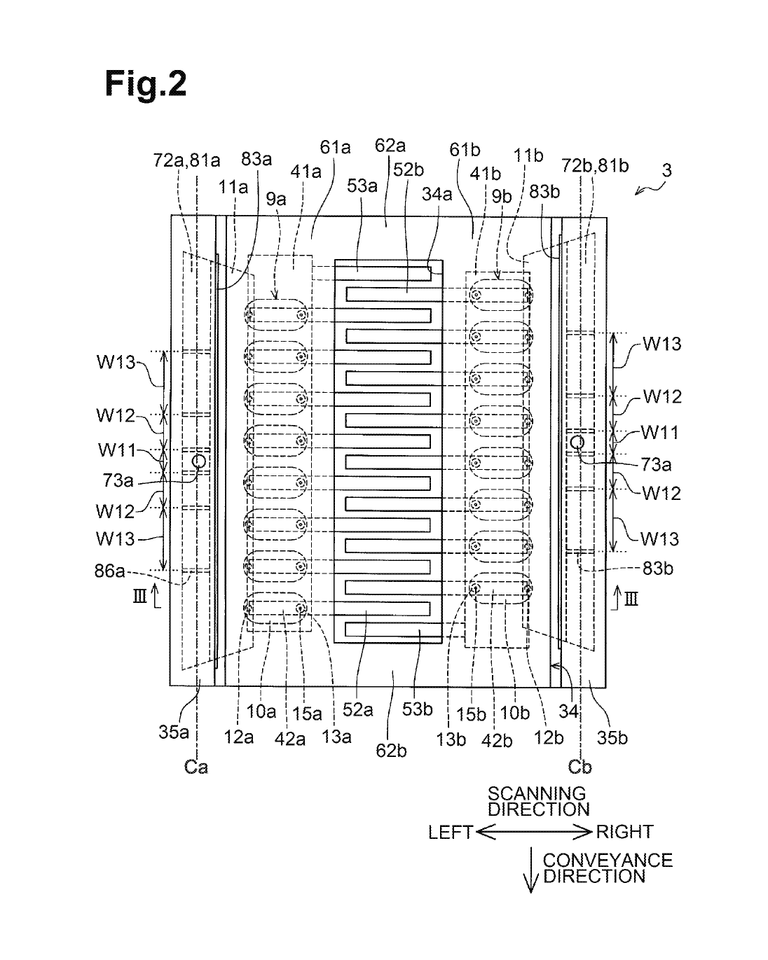

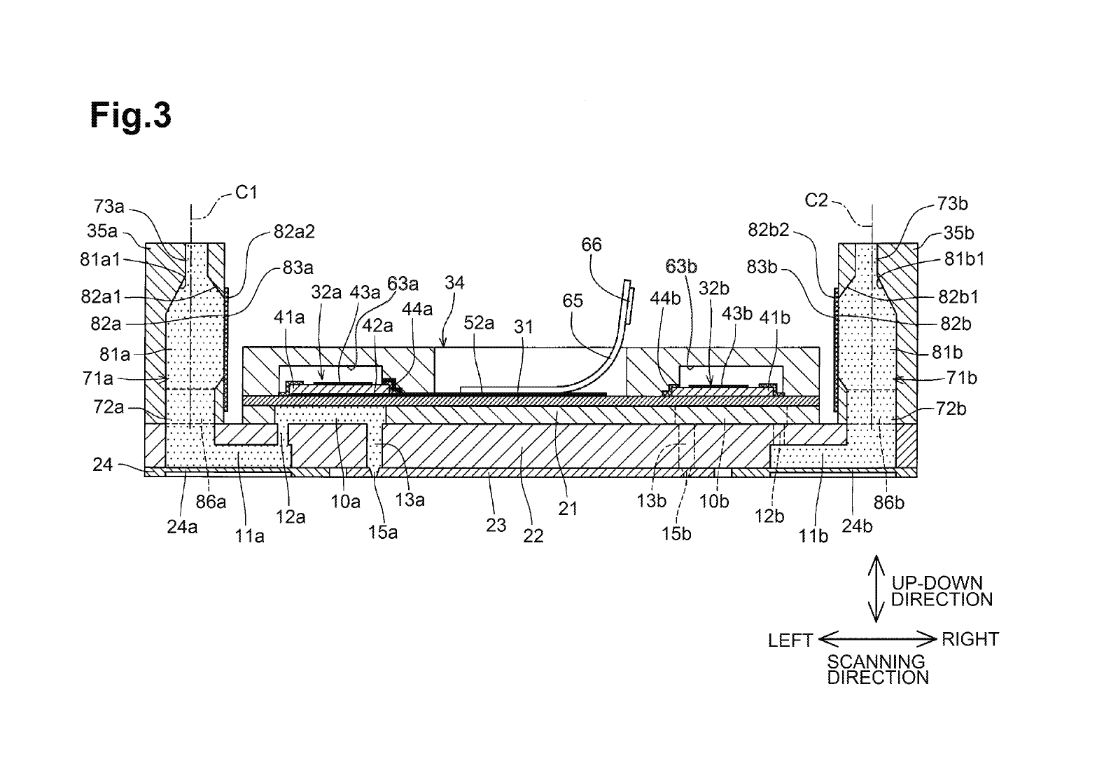

The inkjet head 3 will be described in detail. As depicted in FIGS. 2 and 3, the inkjet head 3 includes a pressure chamber plate 21, a manifold plate 22, a nozzle plate 23, a cover plate 24, a vibration film 31, piezoelectric actuators 32a and 32b, a support plate 34, and ink supply members 35a and 35b.

The pressure chamber plate 21 may be made of, for example, silicon (Si), and has a plurality of through holes. The through holes have an oval shape at their ends and are elongated in the scanning direction. The ends of each through hole are closed by the vibration film 31 and the manifold plate 22, respectively, from above and below. This configuration provides a plurality of pressure chambers 10a and 10b. The pressure chambers 10a are aligned along the conveyance direction and constitute a pressure chamber row 9a. The pressure chambers 10b are aligned along the conveyance direction and constitute a pressure chamber row 9b. The pressure chambers 10a and 10b are arranged in a staggered manner throughout while equally spaced from each other in the respective pressure chamber rows 9a and 9b with respect to the conveyance direction. That is, each of the left pressure chambers 10a is positioned downstream of a corresponding one of the right pressure chambers 10b with respect to the conveyance direction by a half of a distance between adjacent pressure chambers 10 in the same one of the pressure chamber rows 9a and 9b.

The manifold plate 22 is joined to a lower surface of the pressure chamber plate 21. The manifold plate 22 is longer in length in the scanning direction than the pressure chamber plate 21 and both end portions of the manifold plate 22 protrude relative to respective ends of the pressure chamber plate 21 in the scanning direction. The manifold plate 22 may be made of, for example, silicon (Si). The manifold plate 22 has a plurality of, for example, two, manifold channels 11a and 11b (as an example of a common liquid chamber), a plurality of throttle channels 12a and 12b, and a plurality of descender channels 13a and 13b.

The manifold channel 11a is defined in a left portion of the manifold plate 22 in the scanning direction and occupies a lower half portion of the manifold plate 22. The manifold channel 11 opens a portion of a lower surface of the manifold plate 22. The manifold channel 11a extends over the pressure chamber row 9a along the conveyance direction, and also extends astride a left end of the pressure chamber plate 21 along the scanning direction. The manifold channel 11a partially coincide with the throttle channels 12a at its right end portion when viewed from above or below in an up-down direction (as an example of a second direction). The manifold channel 11a has a left end portion, which extends upward and opens a portion of an upper surface of the manifold plate 22.

The manifold channel 11a and the manifold channel 11b are symmetric with respect to a central portion of the manifold plate 22 in the scanning direction. That is, the manifold channel 11b extends over the pressure chamber row 9b along the conveyance direction, and also extends astride a right end of the pressure chamber plate 21 along the scanning direction. The manifold channel 11b partially coincides with the throttle channels 12b at its left end portion when viewed from above or below in the up-down direction. The manifold channel 11b has a right end portion, which extends upward and opens another portion of the upper surface of the manifold plate 22.

The throttle channels 12a are defined in the left portion of the manifold plate 22 in the scanning direction and occupy an upper half portion of the manifold plate 22. Each of the throttle channels 12a extends in the up-down direction. Each of the throttle channels 12a has an upper end that is connected with a left end portion of a corresponding one of the pressure chambers 10a, and a lower end that is connected with the manifold channel 11a. The throttle channels 12b are defined in the right portion of the manifold plate 22 in the scanning direction and occupy the upper half portion of the manifold plate 22. Each of the throttle channels 12b connects between a right end portion of a corresponding one of the pressure chambers 10b and the manifold channel 11b. That is, the throttle channels 12 correspond one-to-one to the pressure chambers 10. The throttle channels 12a and 12b are arranged in a staggered manner throughout while equally spaced from each other in each row with respect to the conveyance direction.

The descender channels 13a are defined in the left portion of the manifold plate 22 in the scanning direction and may be through holes penetrating the manifold plate 22. Each of the descender channels 13a has an upper end that is connected with a right end portion of a corresponding one of the pressure chambers 10a, and a lower end that is connected with a corresponding one of the nozzles 15a. Each of the descender channels 13b connects between a left end portion of a corresponding one of the pressure chambers 10b and a corresponding one of the nozzles 15b in the left end portion of the manifold plate 22 in the scanning direction. That is, the descender channels 13 correspond one-to-one to the pressure chambers 10. The descender channels 13a and 13b are arranged in a staggered manner throughout while equally spaced from each other in each row with respect to the conveyance direction.

The nozzle plate 23 may be made of, for example, synthetic resin material. The nozzle plate 23 is joined to a central portion of the lower surface of the manifold plate 22. The nozzle plate 23 has the plurality of nozzles 15a and 15b. The nozzles 15 correspond to one-to-one to the descender channels 13. Each of the nozzles 15a and 15b is tapered towards its ejection opening. In light of uniformity of shape and size between the nozzles, in other embodiments, for example, the nozzle plate 23 may be made of silicon.

As described above, one of throttle channels 12, one of descender channels 13, and one of nozzles 15 are in communication with one of pressure chamber 10, which defines one of individual ink channels extending from a termination of one of the manifold channels 11. Therefore, a plurality of individual ink channels are defined in the right and left portions of the inkjet head 3 with respect to the central portion of the inkjet head 3. The right and left individual ink channels are symmetrically positioned with respect to the central portion of the inkjet head 3 in the conveyance direction irrespective of the staggered arrangement in the conveying direction.

The cover plate 24 may be made of, for example, metallic material. The cover plate 24 is joined to the lower surface of the manifold plate 22 and surrounds the nozzle plate 23. The cover plate 24 closes the lower openings of the manifold channels 11a and 11b. The cover plate 24 includes particular portions 24a and 24b, which coincide with the respective manifold channels 11a and 11b and have flexibility. Each of the portions 24a and 24b may be a recessed portion formed by half-etching the cover plate 24. The portions 24a and 24b each have a thin portion functioning as a damper film. The portions 24a and 24b are deformable due to ink pressure so as to reduce pressure fluctuation occurring in the respective manifold channels 11a and 11b. Nevertheless, in other embodiments, for example, the cover plate 24 may be made of flexible material, e.g., synthetic resin. In this case, the cover plate 24 might not require to have half-etching therein.

The vibration film 31 may be made of insulating material, e.g., zirconia (ZrO₂), alumina (Al₂O₃), silicon oxide (SiO₂), or silicon nitride (Si₃N₄). The vibration film 31 is disposed on an upper surface of the pressure chamber plate 21. The vibration film 31 closes the upper ends of all of the pressure chambers 10a and 10b. In the illustrative embodiment, the vibration film 31 covers an upper surface of the pressure chamber plate 21 entirely. In the illustrative embodiment, as depicted in FIG. 3, the vibration film 31 consists of a single layer. Nevertheless, in other embodiments, for example, the vibration film 31 may consist of multiple layers made of various materials.

The piezoelectric actuator 32a includes a piezoelectric layer 41a, a plurality of individual electrodes 42a, a common electrode 43a, and a protective film 44a. The plurality of individual electrodes 42a, the piezoelectric layer 41a, and the common electrode 43a are laminated on one another in this order from below above the vibration film 31. The piezoelectric actuator 32a includes a plurality of piezoelectric elements equal to the number of the individual electrodes 42a. Each of the piezoelectric elements has a laminated structure including a single individual electrode 42a, a corresponding portion of the piezoelectric layer 41a, and a corresponding portion of the common electrode 43a.

The individual electrodes 42a may be made of conductive material, e.g., platinum (Pt). The individual electrodes 42a are provided in one-to-one correspondence with the pressure chambers 10a. The individual electrodes 42a have a strip-like shape or a rectangular shape. A principal portion of each of the individual electrodes 42a overlaps a central portion of a corresponding one of the pressure chambers 10a.

The piezoelectric layer 41a may be made of, for example, piezoelectric material. In the illustrative embodiment, the piezoelectric layer 41a includes lead zirconate titanate mainly. The piezoelectric layer 41a has a band-like shape and extends continuously along the conveyance direction. While the piezoelectric layer 41a overlays on all of the individual electrodes 42a above the vibration film 31 in the conveyance direction, the piezoelectric layer 41a allows a right end portion of each of the individual electrodes 42a to be exposed. Nevertheless, in other embodiments, for example, a plurality of piezoelectric layers 41a may be provided in one-to-one correspondence with the pressure chambers 10a. In still other embodiments, for example, while the piezoelectric layer 41a has a band-like shape similar to the illustrative embodiment, the piezoelectric layer 41a may have slits between portions corresponding to the pressure chambers 10a. In these cases, the protective film 44a may be disposed covering an edge of each of the pressure chambers 10a in plan view.

The common electrode 43a may be made of conductive material, e.g., iridium (Ir). The common electrode 43a is laid on the piezoelectric layer 41a and extends along the piezoelectric layer 41a. The common electrode 43a has a band-like shape and extends over the pressure chamber row 9a along the conveyance direction. The piezoelectric layer 41a has particular portions, each of which is sandwiched between a corresponding portion of the common electrode 43a and one of the individual electrodes 42a. Each of the particular portions of the piezoelectric layer 41a functions as a deformable section (i.e., an active portion) in each of the piezoelectric elements. Each of the individual electrodes 42a includes an active portion. In the illustrative embodiment, each active portion is polarized in a direction from a corresponding individual electrode towards the common electrode (hereinafter, referred to as a “polarization direction”).

The protective film 44a may be made of insulating material, e.g., silicon dioxide (SiO₂) or alumina (Al₂O₃). The protective film 44a covers end portions of the piezoelectric layer 41a having a band-like shape as well as portions of the vibration film 31 neighboring to the piezoelectric layer 41a. In particular, the protective film 44a covers the right end portion of the piezoelectric layer 41a while allowing the right end portion of each of the individual electrodes 42a to be exposed. The protective film 44a reduces or prevents the end portions of the piezoelectric layer 41a and the individual electrodes 42a from being damaged even when the piezoelectric elements are driven.

As voltage is applied between the common electrode 43a and one of the individual electrodes 42a, a corresponding active portion deforms independently. The active portion expands in a thickness direction parallel to the polarization direction and contracts in a surface extending direction orthogonal to the polarization direction. The piezoelectric actuator 32a includes such piezoelectric elements equal to the number of the individual electrodes 42a. As voltage is applied between the common electrode 43a and one of the individual electrodes 42a, a corresponding piezoelectric element deforms to protrude towards a corresponding pressure chamber 10 (e.g., unimorph deformation) in cooperation with the vibration film 31. That is, a single piezoelectric element and a portion of the vibration film 31 corresponding to the piezoelectric element constitute a single actuator (i.e., a unit actuator), and changes volume of a corresponding one of the pressure chambers 10a and 10b.

The piezoelectric actuator 32b includes a piezoelectric layer 41b, a plurality of individual electrodes 42b, a common electrode 43b, and a protective layer 44b. While the piezoelectric actuator 32b has a different arrangement pattern of the piezoelectric elements from the piezoelectric actuator 32a, the piezoelectric actuator 32b includes the same elements as the piezoelectric actuator 32a and the piezoelectric layer 41b is polarized in the same manner as the piezoelectric layer 41a of the piezoelectric actuator 32a. The piezoelectric actuator 32b includes a plurality of piezoelectric elements equal to the number of the individual electrodes 42b.

In the piezoelectric actuators 32a and 32b, the arrangement pattern of the piezoelectric elements reflects the arrangement pattern of the pressure chambers 10. The piezoelectric elements have one-to-one positional correspondence with the pressure chambers 10. The piezoelectric elements are arranged in a staggered manner with respect to the conveyance direction and constitute two piezoelectric element rows. The each of the piezoelectric elements in one row is positioned downstream of a corresponding one of the piezoelectric elements in the other row with respect to the conveyance direction, and the piezoelectric elements are arranged based on the arrangement pattern of the pressure chambers 10. The piezoelectric elements in one row and the piezoelectric elements in the other row are symmetrically positioned with respect to an intermediate area between the piezoelectric element rows irrespective of the staggered arrangement in the conveying direction.

A plurality of individual lead wires 52a and 52b and common lead wires 53a and 53b are disposed at the intermediate area between the piezoelectric element rows (e.g., at an intermediate area between the piezoelectric actuators 32a and 32b) in the scanning direction.

The individual lead wires 52 are provided in one-to-one correspondence with the individual electrodes 42 and may be made of conductive material, e.g., gold (Au) or aluminum (Al). Each of the individual lead wires 52a has a left end located on the protective film 44a, a central portion that is connected with a right end portion (e.g., an exposed portion not covered by the protective film 44a) of a corresponding one of the individual electrodes 42a, and a right end located adjacent to the piezoelectric actuator 32b. The individual lead wires 52b each have a configuration symmetrical to that of the individual lead wires 52a in the scanning direction irrespective of their positions in the conveyance direction. In the illustrative embodiment, the individual lead wires 52a and 52b extend along the scanning direction and are disposed alternately with respect to the conveyance direction.

The common lead wires 53a and 53b may be made of the same conductive material used for the individual lead wires 52a and 52b. The common lead wires 53a and 53b are disposed adjacent to respective opposite ends of a wire row consisting of the individual lead wires 52a and 52b in the conveyance direction. The common lead wire 53a is disposed upstream of the wire row in the conveyance direction and the common lead wire 53b is disposed downstream of the wire row in the conveyance direction. The common lead wire 53a has a left end that is connected with the common electrode 43a and a right end located adjacent to the piezoelectric actuator 32b with respect to the scanning direction. The common lead wire 53b has a right end that is connected with the common electrode 43b and a left end located adjacent to the piezoelectric actuator 32a. While the common lead wires 53a and 53b are located separately from each other with respect to the conveyance direction, the common lead wires 53a and 53b are symmetrically configured to each other with respect to the intermediate area between the piezoelectric element rows in the scanning direction. As described above, the individual lead wires 52 and the common lead wires 53 are concentrated on the intermediate area between the piezoelectric element rows, and therefore, a chip-on-film or chip-on-flex (“COF”) 65 is connected to the intermediate area where the lead wires 52 and 53 are concentrated.

The COF 65 may be a plate-shaped flexible member including signal wirings. The COF 65 further includes a driver IC 66 mounted on a central portion thereof. The COF 65 has one end portion that is connected with the lead wires 52a, 52b, 53a, and 53b at the intermediate area between the piezoelectric element rows. The COF 65 has the other end portion that extends upward and is connected with a circuit board. At the time of driving the piezoelectric elements, the circuit board outputs image data. The driver IC 66 generates a driving signal based on the image data. The driving signal is supplied to each of the piezoelectric elements via a corresponding one of the individual lead wires 52a and 52b. The driving signal may be a pulse signal, which may be a combination of a ground potential and a driving potential (e.g., 20V). The common lead wires 53a and 53b are applied with the ground potential at all times.

(Method for Driving Inkjet Head)

A description will be made on how to eject ink from the nozzles 15 in the inkjet head 3. In the inkjet head 3, while the inkjet head 3 is not driven (e.g., while the inkjet head 3 is in a standby state), all of the individual electrodes 42a and 42b are kept at the ground potential.

For ejecting ink from a particular nozzle 15, a potential of an individual electrode 42 corresponding to the nozzle 15 is changed from the ground potential to the driving potential. When the potential of the individual electrode 42 becomes higher than the potential of the common electrode 43, an electric field that is directed towards the common electrode 43 from the individual electrode 42 occurs at a corresponding active portion of the piezoelectric layer 41. While the active portion contracts in the surface extending direction because the direction that the active portion is polarized is the same as the direction of the electric field, a corresponding portion of the vibration film 31 might not deform even when the electric field occurs. Thus, a difference is caused in deformation degree between the corresponding portion of the piezoelectric layer 41 and the corresponding portion of the vibration film 31, whereby a corresponding piezoelectric element deforms towards a corresponding pressure chamber 10. As the piezoelectric element deforms, ink in the pressure chamber 10 is pressurized, whereby some of ink is ejected from the nozzle 15. Thereafter, as the potential of the individual electrode 42 becomes the ground potential again, the piezoelectric element is restored and the volume of the pressure chamber 10 becomes the original volume that is the volume before the driving potential is applied. At that time, the pressure chamber 10 is refilled with ink supplied from the manifold channel 11, and thus preparation for the next ink ejection (e.g., preparation for the next application of the driving potential) is ready.

(Support Plate)

The support plate 34 may be made of, for example, silicon (Si). The support plate 34 is joined to the upper surface of the vibration film 31. The support plate 34 includes a plurality of, for example, two, pressure-chamber facing portions 61a and 61b and a plurality of, for example, two, connecting portions 62a and 62b. The connecting portion 62a connects between the pressure-chamber facing portions 61a and 61b at an upstream portion of the support plate 34 in the conveyance direction, and the connecting portion 62b connects between the pressure-chamber facing portions 61a and 61b at a downstream portion of the support plate 34 in the conveyance direction. The support plate 34 may be a rectangular frame. The support plate 34 and the pressure chamber plate 21 coincide with each other at their outer edges. The support plate 34 enhances rigidity of the inkjet head 3 and protects the piezoelectric actuators 32 from the outside. The support plate 34 has a central opening 34a. The vibration film 31 is partially exposed (e.g., a most portion of the intermediate area between the piezoelectric element rows is exposed) through the central opening 34a. The COF 65 protrudes relative to the support plate 34 through the central opening 34a. Nevertheless, in other embodiments, for example, in consideration of a stable electrical connection of the COF 65, the central opening 34a may be filled with an adhesive agent or a molding agent.

The pressure-chamber facing portion 61a constitutes a left portion of the support plate 34 in the scanning direction and faces the pressure chamber row 9a of the pressure chamber plate 21. The pressure-chamber facing portion 61a has a recessed portion 63a in its lower surface. The recessed portion 63a overlaps the pressure chamber row 9a in plan view, and accommodates all of the pressure chambers 10a therein. Therefore, a most portion of the piezoelectric actuator 32a is accommodated in a space defined by the recessed portion 63a and the vibration film 31.

The pressure-chamber facing portion 61b is symmetrically configured and positioned to the pressure-chamber facing portion 61a with respect to the central opening 34a. The pressure-chamber facing portion 61b has a recessed portion 63b in its lower surface. A most portion of the piezoelectric actuator 32b is accommodated in a space defined by the recessed portion 63b and the vibration film 31.

(Ink Supply Members)

The ink supply members 35 may be made of, for example, synthetic resin material, and supply ink to the manifold plate 22. The ink supply members 35 are provided in one-to-one correspondence with the manifold channels 11. In the illustrative embodiment, the inkjet head 3 includes two ink supply members 35a and 35b, which are disposed at respective opposite end portions of the manifold plate 22 in the scanning direction. Each of the ink supply members 35a and 35b extends across the manifold plate 22 in the conveyance direction. Each of the ink supply members 35 includes a damper portion 71, a communication channel 72, and a supply channel 73. As depicted in FIG. 3, the ink supply members 35a and 35b are symmetrically configured and positioned with respect to the support member 34. Hereinafter, therefore, the left ink supply member 35a in the scanning direction will be described in detail as an example.

The ink supply member 35a includes a damper portion 71a. The damper portion 71a includes a damper chamber 81a, an opening 82a, and a damper film 83a (as an example of a damper film or a first damper film). The damper chamber 81a connects between a supply channel 73a and a communication channel 72a smoothly. The supply channel 73a is defined in an upper portion of the ink supply member 35a. The communication channel 72a is defined in a lower portion of the ink supply member 35. The damper chamber 81a includes a tapered upper portion having inclined surfaces. The tapered upper portion of the damper chamber 81a is contiguous to the supply channel 73a having a relatively small cross section. For example, as depicted in FIG. 3, the damper chamber 81a has a left inner-wall surface 81a1 whose upper portion is located further to the right than whose lower portion. The damper chamber 81a has a lower portion, which extends along the conveyance direction and coincides with the entire length of the communication channel 72a when viewed from above or below. With this configuration, the damper chamber 81a has a cross-sectional area extending orthogonal to the up-down direction, which decreases with its height.

The opening 82a is defined in a right sidewall of the damper portion 71a in the scanning direction and exposes the damper chamber 81a therethrough. The opening 82a is defined by an edge portion 82a1. The edge portion 82a1 is tapered such that the opening 82a has a cross-sectional area extending orthogonal to the scanning direction, which decreases with distance towards the right in the scanning direction (e.g., towards the outside).

The damper film 83a may be a flexible film-like member. The damper film 83a is adhered to an exterior surface of the sidewall having the opening 82a so as to cover the opening 82a. The damper film 83a defines the damper chamber 81a. The damper film 83a is configured to deform to reduce ink pressure fluctuation occurring in the damper chamber 81a.

The communication channel 72a is defined in the lower portion of the ink supply member 35a and connects between the damper chamber 81a and an upper opening of the manifold channel 11a smoothly. The communication channel 72a has a lower portion, which extends along the conveyance direction and coincides with the entire length of the opening of the manifold channel 11a when viewed from above or below.

In the communication channel 72a, a plurality of flow-adjusting ribs 86a are disposed side by side in the conveyance direction. The flow-adjusting ribs 86a are plates that makes the liquid supply amount uniform in the conveyance direction. A central portion of the communication channel 72a in the conveyance direction faces the supply channel 73a. Therefore, an interval between each adjacent two of the flow-adjusting ribs 86a increases with distance from the central portion of the communication channel 72a (e.g., interval W11<interval W12<interval W13 in FIG. 2). The interval between adjacent two of the flow-adjusting ribs 86a means an interval between centers of adjacent two of the ribs 86a in the scanning direction. These centers of flow-adjusting ribs 86a in the scanning direction intersect a center line Ca of the communication channel 72a in scanning direction. Each of the flow-adjusting ribs 86a connects between opposite inner-wall surfaces of the communication channel 72a in the scanning direction. With this configuration, the communication channel 72a is divided into several sections by the flow-adjusting ribs 86a with respect to the conveyance direction.

The flow-adjusting ribs 86a ensure uniform ink flow in the communication channel 72a. And the flow-adjusting ribs 86a support the right sidewall of the communication channel 72a from inside of the communication channel 72a against a film adhering direction at the time of adhering the damper film 83a to the right sidewall. That is, the flow-adjusting ribs 86a may serve as plates that makes resistance to liquid flow for making the liquid supply amount uniform in the conveyance direction. And the flow-adjusting ribs 86a may serve as structural reinforcing members.

As depicted in FIG. 2, the supply channel 73a may be a tubular hole. The supply channel 73a coincides with a central portion of the damper chamber 81a in the conveyance direction. The supply channel 73a has a lower end, which is positioned higher than an upper edge 82a2 defining the opening 82a. The supply channel 73a is positioned to the right of a center line C1 of the damper chamber 81a in the scanning direction. In other words, the supply channel 73a is positioned closer to the right sidewall of the damper portion 71a than a left sidewall of the damper portion 71a in the scanning direction. The supply channel 73a has an upper end, which is connected to an ink cartridge (not depicted) via, for example, a tube (not depicted).

The ink supply member 35b may be made of the same material used for the ink supply member 35a. The ink supply member 35b has a configuration symmetrical to that of the ink supply member 35a with respect to the support member 34. More specifically, for example, the ink supply member 35b includes a damper portion 71b, a communication channel 72b, and a supply channel 73b, each of which has a structural feature that is the same as a corresponding one of the portions of the ink supply member 35a. For example, the damper portion 71b includes a damper chamber 81b, an opening 82B, and an edge portion 82b1 and an upper edge 82b2 defining the opening 82B, which are disposed at respective corresponding positions to the positions of their correspondences in the damper portion 71a and have the same or similar configurations respectively to their correspondences in the damper portion 71a. A plurality of flow-adjusting ribs 86b are disposed in the communication channel 72b and has the same or similar configuration to the flow-adjusting ribs 86a disposed in the damper portion 71a. The supply channel 73b has the same or similar configuration to the supply channel 73a of the damper portion 71a and has the same or similar positional relationship with other portions to the positional relationship that the supply channel 73a of the damper portion 71a has. The interval between each adjacent two of the flow-adjusting ribs 86b increases with distance from the central portion of the communication channel 72b (e.g., interval W11 <interval W12<interval W13 in FIG. 2). The interval between adjacent two of the flow-adjusting ribs 86b means an interval between centers of adjacent two of the flow-adjusting ribs 86b in the scanning direction. These centers of flow-adjusting ribs 86b in the scanning direction intersect a center line Cb of the communication channel 72b in scanning direction.

With this configuration, in each of the right and left portions of the inkjet head 3, ink supplied into the supply channel 73 from the outside of the inkjet head 3 spreads over the damper chamber 81 and flows into the manifold channel 11 via the communication channel 72. Meanwhile, when pressure fluctuation occurs in ink, the damper film 83 reduces and removes the pressure fluctuation. When an ink-flow speed distribution fluctuates, the flow-adjusting ribs 86 make the speed distribution uniform. Ink then further flows into individual ink channels from the manifold channel 11. In each of the individual ink channels, ink flows to the nozzle 15 through the throttle channel 12, the pressure chamber 10, and the descender channel 13. As a particular piezoelectric element is driven, a volume of a corresponding pressure chamber 10 changes, whereby an ink droplet is ejected from a corresponding nozzle 15.

In the illustrative embodiment, each of the ink supply members 35 changes a form of the ink flow channel as well as supplying ink. For example, each of the ink supply members 35 changes the form of the ink flow channel defined therein from one form (e.g., a tubular channel) to another form (e.g., a channel having an elongated slit-like shape in cross section (e.g., the manifold channel 11)). As ink in a pressure chamber 10 is consumed by driving of a particular piezoelectric element, the pressure chamber 10 is refilled with ink supplied from the tube by a negative pressure caused in the pressure chamber 10. In the ink supply member 35, ink flows towards the damper chamber 81 from the supply channel 73. In the damper chamber 81, ink flow may be controlled by the internal shape of the supply channel 73 depending on an ink refill amount. More specifically, for example, in each of the damper chamber 81 and the communication channel 72, a relatively large amount of ink flows at a location facing the supply channel 73 and the ink flow amount decreases with distance from the location facing the supply channel 73. In the damper chamber 81 and the communication channel 72, the ink flow amount has a distribution having a peak at their central portions in the conveyance direction and a less amount at their end portions in the conveyance direction. In the illustrative embodiment, the flow-adjusting ribs 86a and 86b are disposed in the respective communication channels 72a and 72b. The interval between each adjacent two of the flow-adjusting ribs 86a and the interval between each adjacent two of the flow-adjusting ribs 86b decrease with distance closer to the central portions of the communication channels 72a and 72b, respectively, in the conveyance direction. Since the flow-adjusting ribs 86a and 86b are resistances to ink flow, ink may get harder to flow at the central portions of the communication channels 72a and 72b than the end portions of the communication channels 72a and 72b. Accordingly, ink may be supplied equally to the entire portion of the manifold channels 11a and 11b from the respective communication channels 72a and 72b irrespective of locations.

In the illustrative embodiment, the damper portions 71a and 71b are located upstream of the respective manifold channels 11a and 11b in a direction in which ink flows (hereinafter, referred to as an “ink flow direction”). Therefore, pressure fluctuation of ink to be supplied to the manifold channels 11a and 11b may be reduced more effectively. In the illustrative embodiment, the ink supply members 35a and 35b are reinforced with the respective flow-adjusting ribs 86a and 86b. Therefore, damage on the ink supply members 35a and 35b may be avoided at the time of adhering the damper films 83a and 83b to the respective ink supply members 35a and 35b.

In the illustrative embodiment, the edge portion 82a1 of the opening 82a and the edge portion 82b1 of the opening 82b are tapered such that each of the openings 82a and 82b has a cross-sectional area extending orthogonal to the scanning direction, which decreases with distance towards the outside from a corresponding one of the damper chambers 81a and 81b. With this configuration, air bubbles may hardly stay at the edge portions 82a1 and 82b1 and their surroundings.

As ink is ejected from the nozzles 15a and 15b as described above, pressure in the damper chambers 81a and 81b decreases temporarily and the damper films 83a and 83b deform towards the inside of the damper chambers 81a and 81b, respectively. At that time, if however the lower ends of the supply channels 73a and 73b are located at the same height as the upper edges 82a2 and 82b2 of the openings 82a and 82b, respectively, the deformed damper films 83a and 83b may close the respective supply channels 73a and 73b, resulting in causing a shortage of ink supply.

As opposed to this, in the illustrative embodiment, the lower ends of the supply channels 73a and 73b are located higher than the upper edges 82a2 and 82b2 of the openings 82a and 82b, respectively. Therefore, a clearance is ensured between the damper film 83a and the supply channel 73a and between the damper film 83b and the supply channel 73b. With this configuration, the deformed damper films 83a and 83b might not close the respective supply channels 73a and 73b.

In the illustrative embodiment, the supply channels 73a and 73b are positioned closer to the respective openings 82a and 82b relative to the center lines C1 and C2 of the damper chambers 81a and 81b, respectively. Therefore, when the damper films 83a and 83b deform towards the inside of the damper chambers 81a and 81b, respectively, ink flowing into the damper chambers 81a and 81b may hit the respective damper films 83a and 83b easily. Accordingly, ink pressure fluctuation occurring in the damper chambers 81a and 81b may be reduced effectively.

Considering that ink flowing into the damper chambers 81a and 81b is made to reach the damper films 83a and 83b easily while the damper films 83a and 83b deform towards the inside of the respective damper chambers 81a and 81b, it may be preferable that the supply channels 73a and 73b are positioned closer to the openings 82a and 82b, respectively, in the scanning direction relative to the respective center lines C1 and C2 such that the supply channels 73a and 73b overlap the respective deformed damper films 83a and 83b when viewed from above or below.

In the illustrative embodiment, the upper portion of the left inner-wall surface 81a1 (e.g., the inner-wall surface opposite to the opening 82a of the damper chamber 81a) of the damper chamber 81a is located further to the right than the lower portion of the left inner-wall surface 81a1 and an upper portion of a right inner-wall surface 81b1 (e.g., the inner-wall surface opposite to the opening 82b of the damper chamber 81b) of the damper chamber 81b is located further to the left than the lower portion of the right inner-wall surface 81b1. Thus, each of the damper chambers 81a and 81b has a cross-sectional area extending orthogonal to the up-down direction, which decreases with its height. Therefore, air existing in the damper chambers 81a and 81b may move easily towards the supply channels 73a and 73b along the respective inclined inner-wall surfaces 81a1 and 81b1, whereby air may hardly stay in the damper chambers 81a and 81b. Accordingly, this configuration may reduce air flow into the individual ink channels.

In the illustrative embodiment, the damper films 83a and 83b are adhered to the respective sidewalls of the damper portion 71a (e.g., the right sidewall of the damper portion 71a) and the damper portion 71b (e.g., the left sidewall of the damper portion 71b) (i.e., the facing inner sidewalls of the damper portions 71a and 71b). Therefore, this configuration may reduce direct application of an exterior force to the damper films 83a and 83b. Accordingly, the damper films 83a and 83b may hardly be damaged during manufacture of the inkjet head 3.

In the illustrative embodiment, the lower walls defining the respective manifold channels 11a and 1b function as damper films for reducing pressure fluctuation when ink flows downward from the communication channels 72a and 72b to the respective manifold channels 11a and 11b. Ink flowing into the manifold channels 11a and 11b moves towards the lower walls functioning as the dampers and further moves along the lower walls. Therefore, ink pressure fluctuation occurring in the manifold channels 11a and 11b may be surely reduced.

Due to ink ejection, unnecessary vibration may remain in the manifold channels 11a and 11b. Even when such vibration occurs, the lower walls functioning as the damper films (e.g., the portions 24a and 24b) may reduce the vibration effectively, whereby liquid crosstalk between adjacent pressure chambers 10 and breakage of meniscus of ink may be reduced or prevented.

While the disclosure has been described in detail with reference to the specific embodiment thereof, this is merely an example, and various changes, arrangements and modifications may be applied therein without departing from the spirit and scope of the disclosure.

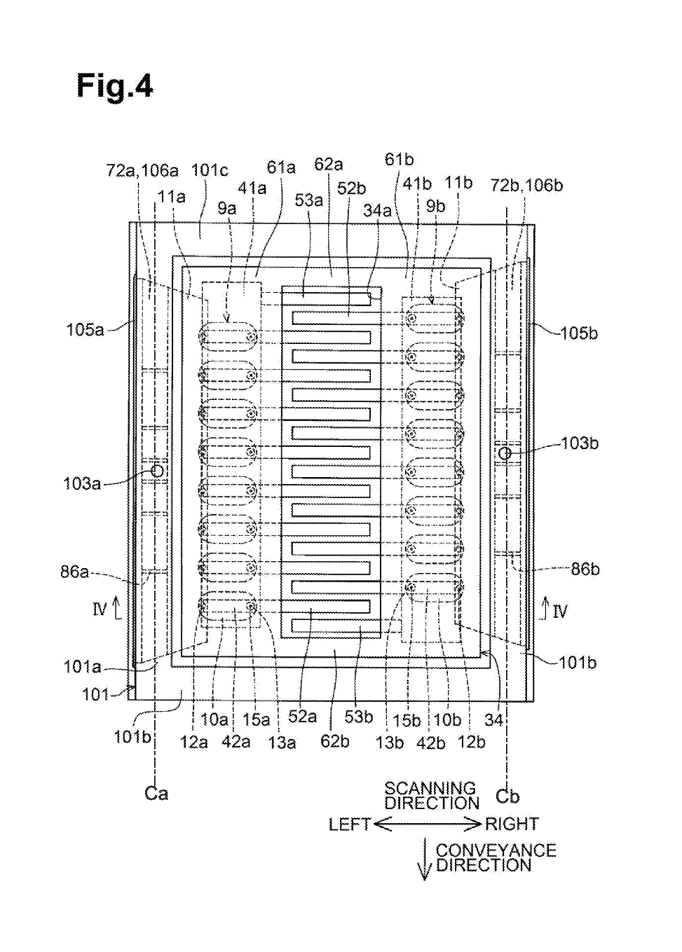

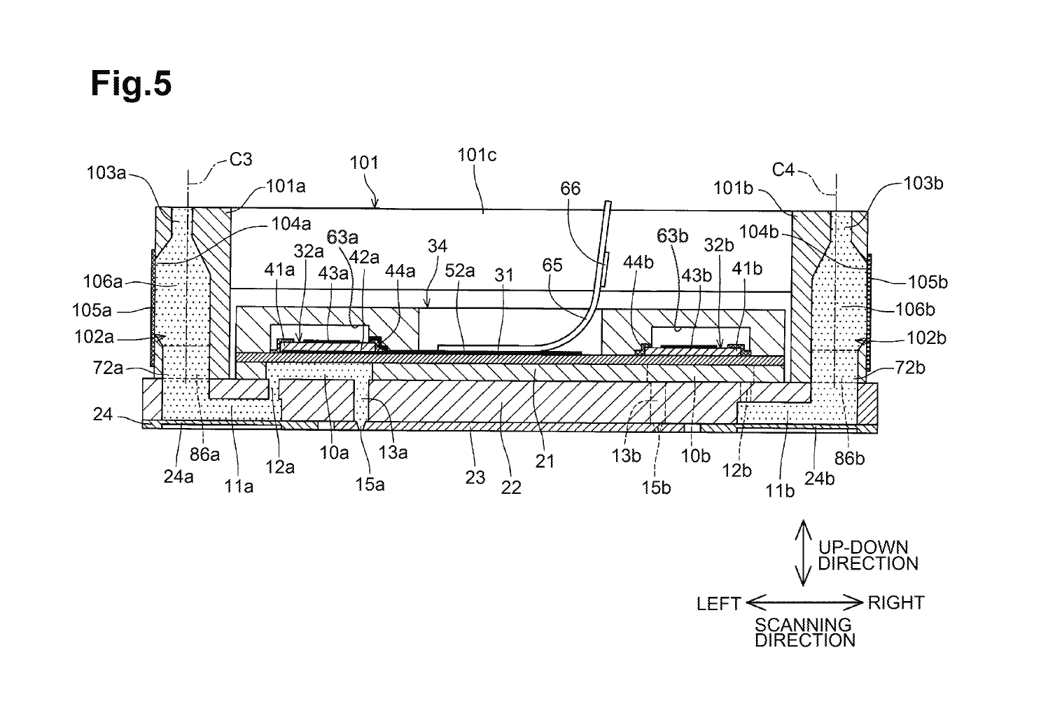

In the illustrative embodiment, the ink supply members 35a and 35b are provided independently and the openings 82a and 82b are defined in the facing inner sidewalls of the damper portions 71a and 71b in the scanning direction. Nevertheless, the configurations of the ink supply members 35a and 35b are not limited to the specific example. For example, in a first variation, as depicted in FIGS. 4 and 5, an inkjet head 3 includes a single ink supply member 101 and has a plurality of, for example, two, openings 104a and 104b at the other sidewalls of the damper portions 71a and 71b, which might not face each other in the scanning direction (i.e., outer sidewalls).

As depicted in FIG. 4, the ink supply member 101 may have a frame-like shape. The entire portion of the support member 34 is located inside an opening defined by an inner circumference of the ink supply member 101. The ink supply member 101 includes a plurality of, for example, two, channel-defining portions 101a and 101b, and a plurality of, for example, two, connecting portions 101c and 101d. Each of the connecting portions 101c and 101d connect between ends of the channel-defining portions 101a and 101b in the conveyance direction. Each of the channel-defining portions 101 also changes a form of an ink flow channel similar to each of the ink supply members 35.

The ink supply member 101 has symmetry about a line extending along the conveyance direction through the center of the inkjet head 3 with respect to the scanning direction. Hereinafter, the left configuration of the ink supply member 101 in the scanning direction will be described.

The channel-defining portion 101a is disposed on a left end portion of the upper surface of the manifold plate 22 in the scanning direction. The channel-defining portion 101a includes a damper portion 102a, a communication channel 72a, and a supply channel 103a similar to the ink supply member 35a.

In the damper portion 102a, the opening 104a is defined in the left sidewall (i.e., the outer sidewall) of the damper portion 102a in the scanning direction. A damper film 105a is adhered to an exterior surface of the left sidewall of the damper portion 102a so as to close the opening 104a. The supply channel 103a is positioned to the left of a center line C3 of a damper chamber 106a (e.g., closer to the damper film 105a relative to the center line C3 of the damper chamber 106a).

The connecting portion 101c extends along the scanning direction and connects between the upstream ends of the channel-defining portions 101a and 101b in the conveyance direction. The connecting portion 101d extends along the scanning direction and connects the downstream ends of the channel-defining portions 101a and 101b in the conveyance direction.

In the illustrative embodiment, if a single ink supply member in which the ink supply members 35a and 35b are joined to each other is provided instead of providing the ink supply members 35a and 35b independently, it may be difficult to adhere the damper films 83a and 83b to the respective portions.

As opposed to this, in the first variation, the openings 104a and 104b are defined in the outer sidewalls of the damper portions 102a and 102b, respectively, in the scanning direction. Therefore, at the time of assembling the ink supply member 101, the damper films 105a and 105b may be adhered to the damper portions 102a and 102b from the outside simply and thus its operability may be high. The single ink supply member 101 includes two channel-defining portions 101a and 101b, whereby a parts count may be reduced.

In one example, even when the openings 104a and 104b are defined in the outer sidewalls of the damper portions 102a and 102b, respectively, in the scanning direction as described in the first variation, a member corresponding to the channel-defining portion 101a and another member corresponding to the channel-defining portion 101b may be provided independently.

In another example, even when the openings 82a and 82b are defined in the facing inner sidewalls of the damper portions 71a and 71b, respectively, in the scanning direction as described in the illustrative embodiment, a single ink supply member including portions corresponding to the ink supply members 35a and 35b may be adopted if it is possible to adhere the damper films 83a and 83b to the respective portions of the facing inner sidewalls of the damper portions 71a and 71b, respectively.

In the illustrative embodiment, the inner-wall surfaces of the damper chambers 81a and 81b opposite to the respective damper films 83a and 83b in the scanning direction are angled relative to the conveyance direction and the up-down direction. Nevertheless, in other embodiments, for example, the inner-wall surfaces of the damper chambers 81a and 81b may extend parallel to the conveyance direction and the up-down direction.

In the illustrative embodiment, the supply channels 73a and 73b are positioned closer to the respective damper films 83a and 83b relative to the center lines C1 and C2 of the damper chambers 81a and 81b, respectively.

Nevertheless, in other embodiments, for example, the supply channels 73a and 73b may be positioned such that center lines of the supply channels 73a and 73b coincide with the center lines C1 and C2 of the damper chambers 81a and 81b, respectively. In still other embodiments, the supply channels 73a and 73b may be positioned farther from the respective damper films 83a and 83b relative to the respective center lines C1 and C2.

In the illustrative embodiment, the lower ends of the supply channels 73a and 73b are located higher than the upper edges 82a2 of the openings 82a and 82b, respectively. Nevertheless, in other embodiments, for example, the lower ends of the supply channels 73a and 73b may be located at the same height as the upper edges 82a2 of the openings 82a and 82b, respectively.

In the illustrative embodiment, the edge portion 82a1 of the opening 82a and the edge portion 82b1 of the opening 82b are tapered such that each of the openings 82a and 82b has a cross-sectional area extending orthogonal to the scanning direction, which decreases with distance towards the outside from a corresponding one of the damper chambers 81a and 81b. Nevertheless, in other embodiments, for example, the edge portions 82a1 and 82b1 might not necessarily be tapered, but may extend parallel to the scanning direction.

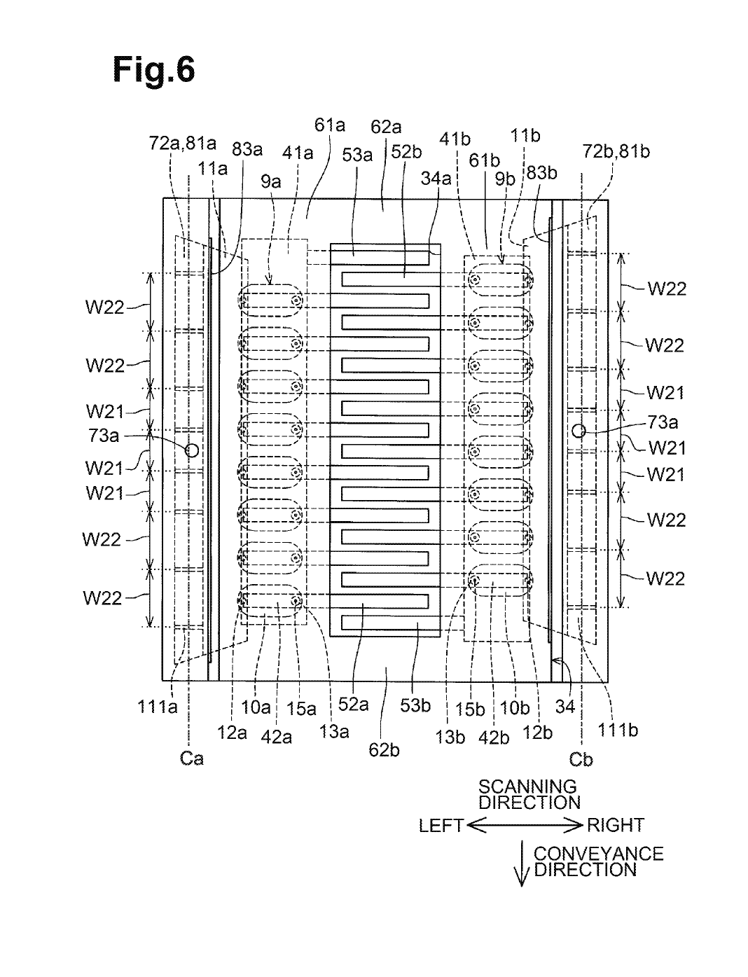

In the illustrative embodiment, the interval between each adjacent two of the flow-adjusting ribs 86a increases with distance from the central portion of the communication channel 72a, and the interval between each adjacent two of the flow-adjusting ribs 86b increases with distance from the central portion of the communication channel 72b. Nevertheless, the arrangement pattern of the flow-adjusting ribs 86a and 86b is not limited to the specific example. For example, in a second variation, as depicted in FIG. 6, a plurality of flow-adjusting ribs 111a are disposed in the communication channel 72a and a plurality of flow-adjusting ribs 111b are disposed in the communication channel and 72b. Some of the plurality of flow-adjusting ribs 111a and 111b disposed at a central portion of each of the communication channels 72a and 72b are equally spaced at a certain interval, which may be a first interval W21. The remainder of the plurality of flow-adjusting ribs 111a and 111b disposed at end portions of each of the communication channels 72a and 72b are equally spaced at another certain interval, which may be a second interval W22 greater than the first interval W21. In this case, also, ink may get harder to flow at the central portions of the communication channels 72a and 72b than the end portions of the communication channels 72a and 72b in the conveyance direction.

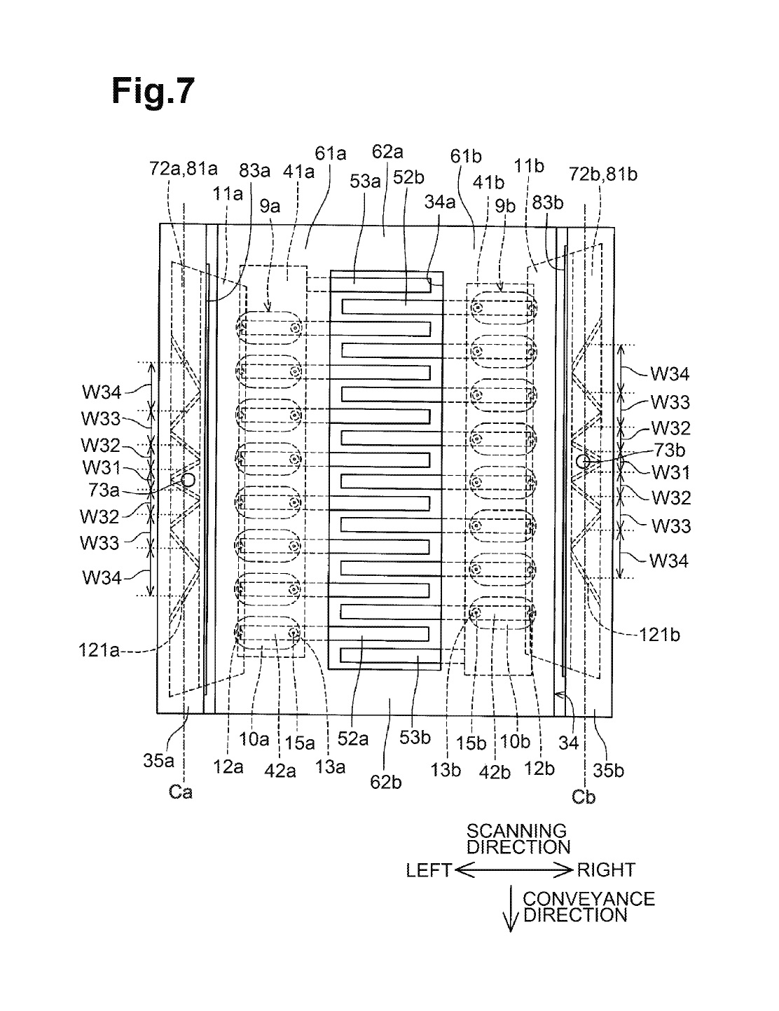

In the illustrative embodiment, the flow-adjusting ribs 86a, 86b extend parallel to the scanning direction. Nevertheless, the extending direction is not limited to the specific example. For example, in a third variation, as depicted in FIG. 7, a plurality of flow-adjusting ribs 121a are angled relative to the scanning direction in the communication channel 72a. Adjacent two of the flow-adjusting ribs 121a are angled towards respective directions opposite to each other with respect to the scanning direction. An inclination of the flow-adjusting ribs 121a relative to the scanning direction becomes greater with distance from the central portion of the communication channel 72a. Thus, an interval between centers of each adjacent two of the flow-adjusting ribs 121a in the scanning direction increases with distance from the central portion of the communication channel 72a in the conveyance direction (e.g., interval W31<interval W32<interval W33<interval W34 in FIG. 7). The interval between adjacent two of the flow-adjusting ribs 121a means an interval between centers of adjacent two of the flow-adjusting ribs 121a in the scanning direction. These centers of the flow-adjusting ribs 121a in the scanning direction intersect a center line Ca of the communication channel 72a in scanning direction. A plurality of flow-adjusting ribs 121b are disposed in the communication channel 72b in a similar manner to the plurality of flow-adjusting ribs 121a.

In the illustrative embodiment, the damper chambers 81a and 81b are connected with the respective communication channels 72a and 72b while the damper chambers 81a and 81b are located upstream of the communication channels 72a and 72b, respectively, in the ink flow direction. Nevertheless, in other embodiments, for example, ink channels, each of which might not include a wall including a damper film, may be connected with the respective communication channels 72a and 72b, respectively, while the ink channels are located upstream of the respective communication channels 72a and 72b.

In the illustrative embodiment, the inkjet head 3 includes two manifold channels 11a and 11b and two each of the damper portions 71, the communication channels 72, and the supply channels 73 corresponding to each of the manifold channels 11a and 11b. Nevertheless, in other embodiments, for example, an inkjet head may include a single manifold channel 11 and one each of the damper portion 71, the communication channel 72, and the supply channel 73 corresponding to the manifold channel. In still other embodiments, for example, an inkjet head may include three or more manifold channels 11 and three or more each of channel-defining members corresponding to the number of the manifold channels 11.

In the illustrative embodiment and variations, in the ink supply member 35, 101, the supply channel 73, 103 is positioned at the central portion of the damper chamber 81, 106 in the conveyance direction. Nevertheless, in other embodiments, for example, the supply channel 73, 103 may be positioned at one of the end portions of the damper chamber 81, 106 in the conveyance direction. The portion of the communication channel 72 overlapping the supply channel 73, 103 when viewed from above or below may allow larger amount of ink to flow than the other portion of the communication channel 72. In this case, also, in consideration of equal amount of ink supply, the interval between each adjacent two of the flow-adjusting ribs 86, 111, 121 may be reduced with distance from the overlapping portion.

In the illustrative embodiment and variations, the supply channel 73, 103 coincides with the communication channel 72 while the supply channel 73, 103 might not overlap any of the flow-adjusting ribs 86, 111, 121 when viewed from above or below. Nevertheless, in other embodiments, for example, the supply channel 73, 103 may overlap one or more of the flow-adjusting ribs 86, 111, 121 when viewed from above or below. Even when the ink flow still has a directivity in the up-down direction at the point of the communication channel 72, the flow-adjusting ribs 86, 111, 121 may disperse the directivity in the conveyance direction to make the liquid supply amount uniform in the conveyance direction.

In the illustrative embodiment and variations, in consideration of reachability of ink flow to the damper film 83, 105, the supply channel 73, 103 is positioned closer to the opening 82, 104 relative to the center line C of the damper chamber 83, 105. Nevertheless, in other embodiments, for example, the supply channel 73, 103 may be disposed such that, at the time the damper film 83, 105 deforms maximum, the supply channel 73, 103 overlaps the damper film 83, 105 when viewed from above or below. With this configuration, the damper film 83, 105 may act on ink flow directly and the damper film 83, 105 may further reduce pressure fluctuation.

The description has been made on the example in which the disclosure is applied to the inkjet head for ejecting ink from the nozzles. Nevertheless, in other embodiments, for example, the disclosure may be applied to other liquid ejection devices for ejecting ink from nozzles

What is claimed is:

1. A liquid ejection device comprising:
a first common liquid chamber and a second common liquid chamber, both the first common liquid chamber and the second common liquid chamber extend along a longitudinal direction;
a first liquid supply member defining a first liquid supply channel that is in communication with the first common liquid chamber via an outlet of the first liquid supply channel, the outlet of the first liquid supply channel extends along the longitudinal direction;
a second liquid supply member defining a second liquid supply channel that is in communication with the second common liquid chamber via an outlet of the second liquid supply channel, the outlet extends along the longitudinal direction; and
wherein the first liquid supply member defines a first opening and includes a first damper film that covers the first opening;
the second liquid supply member defines a second opening and includes a second damper film that covers the second opening;
the first opening and the second opening face each other in a transverse direction, the transverse direction is orthogonal to the longitudinal direction.

2. The liquid ejection device according to claim 1,
wherein the first liquid supply member includes a plurality of ribs located within the first liquid supply channel, the plurality of ribs are disposed side by side in the longitudinal direction.

3. The liquid ejection device according to claim 2,
wherein the plurality of ribs incudes a first rib, a second rib and a third rib;
the second rib is disposed in a first direction of the first rib, the first direction is in the longitudinal direction;
the third rib and an inlet of the first liquid supply channel are disposed in a second direction of the first rib, the second direction is in the longitudinal direction and opposite to first direction;
a distance from the first rib to the third rib in the longitudinal direction is smaller than a distance from the first rib to the second rib in the longitudinal direction.

4. A liquid ejection device comprising:
a liquid supply member defining a liquid supply channel that is in communication with a common liquid chamber via an outlet of the liquid supply channel, the outlet and the common liquid chamber extends along a longitudinal direction respectively; and
wherein the outlet is divided into a plurality of sub-outlets in the longitudinal direction;
the plurality of sub-outlets includes a first sub-outlet and a second sub-outlet, the first sub-outlet is adjacent to the second sub-outlet;
a distance from an inlet of the liquid supply channel to the first sub-outlet in the longitudinal direction is smaller than a distance from the inlet to the second sub-outlet in the longitudinal direction; and,
a length of the first sub-outlet in the longitudinal direction is smaller than a length of the second sub-outlet in the longitudinal direction.

5. The liquid ejection device according to claim 4,
wherein the first sub-outlet is centered below the inlet in a liquid flow direction, the liquid flow direction is a direction from the inlet towards the outlet.
